(19) United States
(12) Patent Application Publication
(10) Pub. No.: US 2019/0371324 A1
(43) Pub. Date: Dec. 5, 2019

(54) SUPPRESSION OF VOICE RESPONSE BY DEVICE RENDERING TRIGGER AUDIO

(71) Applicant: Apple Inc., Cupertino, CA (US)

(72) Inventors: Richard M. Powell, Mountain View, CA (US); Kisun You, Campbell, CA (US); Hywel Richards, Cardiff (GB); Kurt W. Piersol, San Jose, CA (US)

(21) Appl. No.: 16/392,263

(22) Filed: Apr. 23, 2019

Related U.S. Application Data
(60) Provisional application No. 62/679,733, filed on Jun. 1, 2018.

(51) Int. Cl. G10L 15/22; G06F 3/16; G10L 15/30

(52) U.S. Cl. CPC G10L 15/22; G06F 3/167; G10L 2015/088; G10L 2015/223; G10L 15/30

(57) ABSTRACT

An electronic device with voice trigger suppression capability has a wireless communication module and a voice trigger response suppression module. The voice trigger suppression module is to monitor a signal to the speaker, to detect a voice trigger phrase therein and in response send a message through the wireless communication module that communicates to one or more wireless receiving devices that the electronic device, with voice trigger response suppression capability, will handle a voice trigger. Other aspects are also described and claimed.

This nonprovisional application claims the benefit of the earlier filing date of U.S. provisional application No. 62/679,733 filed Jun. 1, 2018.

An aspect of the disclosure here relates to voice response systems. Other aspects are also described.

### BACKGROUND

Computers, smart phones, smart speakers and other electronic devices are often equipped with voice responsive artificial intelligence (AI). Some of these voice responsive AI systems are in the form of a virtual assistant that is activated in response to a detected voice trigger (a phrase of one or more humanly audible words or speech that may include the name of the assistant, e.g., “Hal.”) Saying the voice trigger phrase brings further spoken words, e.g., “Open the door”, to the attention of an automatic speech recognition engine of the virtual assistant, which then recognizes and interprets these further spoken words or phrases as commands, inquiries, requests, etc. and then responds to them through voice output, e.g., “I am sorry Dave but I can't do that.”

### SUMMARY

In one aspect, an electronic device having the ability to automatically suppress a virtual assistant response, by another electronic device that is detecting a voice trigger, and a related method, are described herein. Various mechanisms for such voice trigger response suppression are described that present a technological solution to the problem of undesired voice response by other devices to a voice trigger phrase when the voice trigger phrase is part of the user program audio content of, for example, a movie, a short video, music or commercial that is being rendered for playback.

In one version, the electronic device includes a wireless communication module, an audio rendering module, and a voice trigger response suppression module. The voice trigger response suppression module is to monitor a speaker driver audio signal (in the electronic device, which is also referred to now as a playback device), to detect a voice trigger phrase therein. In response to such detection, the suppression module sends a message through the wireless communication module to communicate, to one or more wireless receiving devices, that the electronic device has voice trigger response suppression capability in that it will handle any virtual assistant response that may be needed to a voice trigger (which may be about to be, or is being, also detected by the receiving device.) In other words, the message results in suppression of the virtual assistant response of the wireless receiving devices.

In one version, the received message may “persist” in the receiving devices (thereby preventing the receiving devices from outputting a virtual assistant response) until a release message is received, e.g., from the same playback device, or until a timer that was set in response to receipt of the suppression message expires.

In one version of a method of voice trigger response suppression for electronic devices, a signal to a speaker of the electronic device (playback device) is monitored. The monitoring is performed by a suppression module in the electronic device. When a voice trigger is detected, through the monitoring, a message is sent through a wireless communication module of the electronic device. The message is to communicate to one or more wireless receiving devices that the electronic device will handle any needed virtual assistant response to a soon to be detected voice trigger or a voice trigger that has just been detected (where the detected voice trigger may also be referred to here as a voice trigger request.) The sending of the message is responsive to detecting the voice trigger through monitoring in the playback device the signal to the speaker.

In one version, an electronic device with voice response suppression capability has a wireless communication module, a speaker and a suppression module. The suppression module is to monitor an audio signal that is driving the speaker, to detect a trigger in the audio signal. The suppression module is to send a message through the wireless communication module, responsive to detecting the trigger in the audio signal that is driving the speaker. The message is to be sent to a wireless receiving device in which a microphone is picking up sound that is being produced by the speaker. The wireless receiving device is normally or regularly configured to respond to the trigger, e.g., via activation of a virtual assistant, but foregoes from doing so in response to receiving the message.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 illustrates an electronic device self-suppressing response to a trigger and communicating to other electronic devices, each of which may have a virtual assistant program executing therein, to suppress their responses to a trigger.

FIG. 2 depicts a variation of the electronic device of FIG. 1, with external suppression of responses to a trigger.

FIG. 3 is a block diagram depicting receiving audio data into a buffer and executing voice trigger detection.

FIG. 4 is a flow diagram of a method of voice trigger response suppression for electronic devices, which can be practiced by an electronic device.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

Electronic devices such as smart phones, smart speakers, tablet computers, and laptop computers are equipped with virtual assistant software, e.g., voice responsive artificial intelligence (AI) capability, that, when executed by a processor in the electronic device, will respond via voice output through a speaker, to any voiced command or inquiry by a user that is detected in a microphone output signal. A voice trigger program “listens” for a voice trigger (also referred to here as a voice trigger phrase, e.g., a predefined phrase of one or more words, such as the name of a virtual assistant), in the local sound field, by monitoring a microphone output signal. Upon detecting the voice trigger, it may activate the virtual assistant software program which then responds to any further spoken words or phrases that the virtual assistant recognizes and interprets in a microphone output signal, which may be commands, inquiries, requests, etc.

There is however a problem with activating the voice responsive AI assistant when the voice trigger phrase, including a phrase that is misinterpreted as an actual voice trigger phrase, is being broadcast as sound through the speaker (rather than being spoken in real-time or in that moment by a user who is present in the local sound field of the device.) For example, a movie soundtrack, music, a short video, a commercial or other user program audio that a user would like to listen to, could contain the voice trigger phrase or a similar sounding phrase, as character dialogue, narration or lyrics. When played back through the speaker, and picked up through a microphone of an electronic device, the voice trigger phrase causes the voice responsive AI assistant to activate and start responding to the voice trigger as well as subsequent or further speech in the microphone output signal, whether from an electronic sound source or from a user who is present in the local sound field. This can be especially problematic where the local sound field is inside of a room, vehicle or other location where the speaker 104 and the microphones 106 are located, e.g., where there are multiple electronic devices each with their own voice responsive module 114 “listening” to the sound field through its respective microphone output signal for the voice trigger phrase.

In some voice responsive AI systems, there is a coordination mechanism in which electronic devices send coordination messages to elect a “winner” when more than one electronic device has detected the voice trigger phrase through their respective microphone output signals. For example, a device could indicate that it will handle a particular, detected voice trigger. This ensures that there is only one device response, to the voice trigger and any subsequent speech by a user, despite multiple devices “hearing” a live user in the room saying the voice trigger. In one version, the coordination messages are sent through wireless connections, which could be Bluetooth Low Energy (BTLE) links, using network packets.

Described herein are examples of electronic devices with voice trigger response suppression capability, as a solution to the above-discussed problem of undesired activation of a virtual assistant due to a voice trigger that is within user program audio content that is being output for playback. Various mechanisms as described here are applicable to various electronic devices, such as smart phones, smart televisions, smart speakers, desktop computers, laptop computers, tablet computers, networked appliances, in-vehicle infotainment systems, etc.

One such mechanism performs self-suppression within an electronic device, that is also termed here as a “playback device”. Self-suppression refers to a process that is executing in the playback device and that monitors the user program audio that is being rendered in the playback device and, in response to detecting a voice trigger through the monitoring, suppresses the activation of a virtual assistant that is also being executed by a processor in the playback device. During normal operation, the voice response of the activated virtual assistant (e.g., “Yes Dave?”) would be output though a speaker that may also be used for sound output of the user program audio that is being rendered into speaker driver audio signals by the playback device.

Another mechanism, also referred to here as external suppression, monitors the user program audio that is being rendered in the playback device and, in response to detecting the voice trigger through the monitoring, suppresses the response by a virtual assistant that is being executed by a processor in another electronic device (not the playback device.) In one aspect, this is done by way of the playback device sending a message over the air to another electronic device (also referred to here as a receiving device.) The receiving device has, executing therein, a virtual assistant that would normally be activated by a voice trigger detector that while monitoring a microphone output signal in the receiving device detects a voice trigger phrase. Combining the self-suppression and the external suppression mechanisms achieves a net, desirable result, namely that none of the devices will output a virtual assistant voice response in that scenario.

The suppression techniques described here may be implemented by one or more processors (generically referred to as “a processor”) executing software that is stored in memory, within a playback device and within one or more receiving devices. Of course, the roles of the playback device and a receiving device as described here may be included in every electronic device, so that the suppression techniques may take place regardless of which electronic device is acting as a playback device and which is acting as a receiving device.

In detail, an example of self-suppression may be described as follows. An electronic device is playing audio that can be heard by a user within a nominal listening range of a speaker. The speaker may be a built-in speaker, e.g., built into the same housing as the playback device, or it may be a remote speaker that is receiving one or more speaker driver audio signals through a cable connection or a wireless connection with the playback device. For example, the playback device may be a network appliance that is connected via an audio communications cable to the audio channel inputs of an audio video receiver. The playback audio (be it the program audio or its rendered version, being speaker driver signals) may be monitored continuously for the voice trigger phrase. When the voice trigger phrase is encountered (detected), the electronic device self-suppresses its own response to the voice trigger, or signals the virtual assistant that is executing in the playback device to forego its normal response.

To ensure that other devices within the same sound field as the playback device also do not respond to the voice trigger, the playback device would perform external suppression, as follows. In response to detecting the voice trigger phrase, a process running in the playback device also sends out one or more coordination messages, wirelessly or through wired connections, to other electronic devices, in effect providing instruction to suppress any voice trigger response in those electronic devices. A coordination message indicates that the originating electronic device will handle any needed response to a voice trigger. This causes the receiving device that has detected the voice trigger phrase through its respective microphone output signal to not handle the voice trigger request, i.e., to not respond to a detected voice trigger phrase. The effect of this mechanism is that when a user is watching a commercial, a short video, or a movie or is listening to a podcast, or more generally any program audio that is undergoing playback in a device through a speaker and in which a person says the voice trigger phrase, the device that is rendering the program audio will suppress the voice responses of all other devices that are in the same sound field (e.g., devices that would detect the voice trigger phrase through their respective microphone signals.)

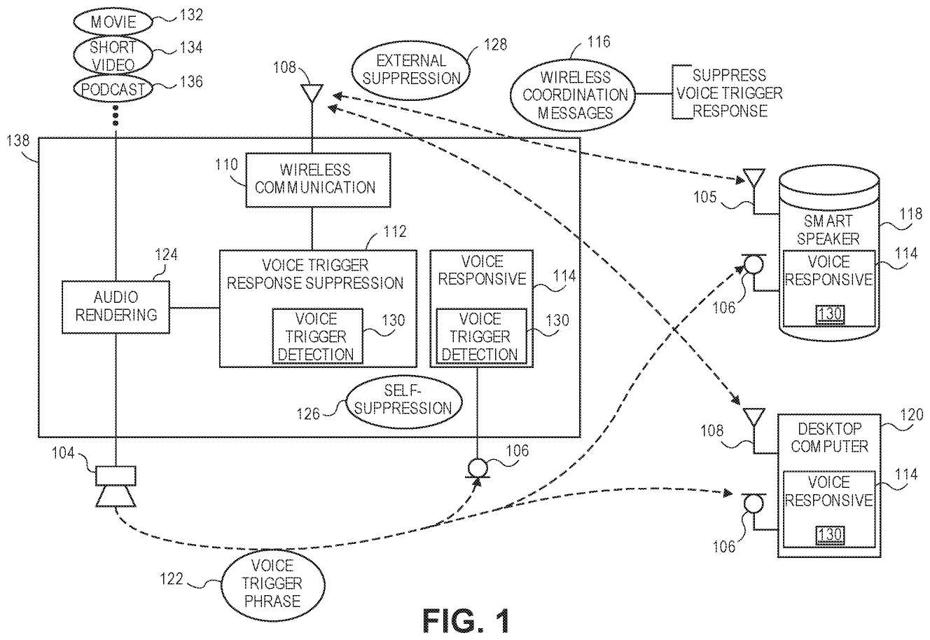

FIG. 1 illustrates an electronic device (e.g., a playback device 138) in which a voice trigger response suppression module 112 is detecting a voice trigger phrase 122 in a signal to a speaker 104—the voice trigger 122 is being output as sound during playback (hence the arrows emanating from the speaker 104.) The playback device 138 is also communicating to other electronic devices that may have a virtual assistant program therein, e.g., with voice responsive artificial intelligence, to suppress their voice trigger response. In this example, the voice trigger phrase 122, which could also be termed an automatic speech recognition (ASR) trigger phrase, is embedded in user program audio, e.g., in a soundtrack of a movie 132 or of a short video 134, a podcast 136, or even a phone call.

The user program audio may be rendered by an audio rendering module 124 which may be part of a media player application program (not shown), while being played back through the speaker 104. Audio rendering here refers to audio signal processing for converting audio signals of the user program audio (e.g., audio channels, audio objects, or both) into a form that is suitable for output through the speaker 104 (e.g., multiple speaker driver signals.) For example, audio rendering module may perform an upmix from left-right two channel stereo input to more than two audio signals for driving more than two speakers (of which the speaker 104 is one), e.g., a 5.1 surround speaker system or a loudspeaker array. In another example, the audio rendering module may perform a downmix from a 5.1 or a 7.1 surround format (e.g., six channels, or eight channels) into two audio signals for driving two speakers only (where each speaker 104 could have multiple drivers and a crossover circuit.) In one aspect, each speaker 104 is a consumer electronics type loudspeaker and may have one or more drivers, e.g., in the same cabinet or enclosure together with a built-in crossover circuit.

A voice trigger response suppression module 112 is coupled to the path of the signal to the speaker 104 as shown. The module 112 recognizes the voice trigger phrase 122 in that signal, through a voice trigger detection module 130 that is processing the signal, looking for the voice trigger phrase in accordance with any known techniques. Note that the signal to the speaker is an audio signal; it may tapped at a point upstream of the audio rendering module 124 (before actually being rendered) or at a point downstream of the audio rendering 124 (after it is rendered into a speaker driver signal).

The voice trigger response suppression module 112 communicates with other devices (receiving devices) through a wireless communication module 110, e.g., a Bluetooth module. The latter is signaled to send out a wireless coordination message 116 to other electronic devices, such as in this example a smart speaker 118 and a desktop computer 120, each of which has an antenna 108, e.g., a radio frequency (RF) antenna, for receiving and sending wireless messages over the air. The wireless coordination message 116 indicates or instructs its recipient to ignore the voice trigger phrase 122, i.e., suppress voice trigger response.

In the example scenario depicted in FIG. 1, there are two wireless receiving devices in the form of a smart speaker 118 and a desktop computer 120 that are listening to their local sound field, by monitoring for the voice trigger phrase 122 through their respective microphone output signals, from in this case two separate microphones 106. They also have respective voice responsive modules 114 (each voice responsive module 114 or VR modules 114 being for example a programmed processor in each of the receiving devices), each of which includes a respective voice trigger detection module 130 and speech recognition-based voice response capability. Each microphone 106 may be integrated within the housing of its respective receiving device. In other scenarios however, the microphone 106 may be “remote” such that its microphone output signal is received by the VR module 114 over the air by for example a wireless communication module 110 in each of the devices, namely the playback device 138 and one or more receiving devices. In both instances, during rendering of the soundtrack of the movie 132 by the audio rendering module 124 for playback through the speaker 104 of the playback device 138, the voice trigger phrase 122 which is “contained” in the movie 132 is normally detected by the VR module 114 in each of the devices (the playback device 138 and the one more receiving devices.)

The voice trigger phrase 122 is also detected by the voice trigger response suppression module 112 in the playback device 138, but through monitoring of a speaker driver audio signal being produced by the audio rendering module 124 (not monitoring a microphone output signal of the playback device 138.) The playback device 138 then self-suppresses its response to the voice trigger phrase 122 by signaling its voice responsive module 114 to forego the normal voice response that would be produced in response to detecting the voice trigger phrase 122 in the microphone output signal (from the microphone 106 of the playback device.) Also, the playback device 138 sends one or more wireless coordination messages 116 to suppress voice trigger response of other electronic devices (here, the smart speaker 118 and the desktop computer 120.) The smart speaker 118 and computer 120 receive the wireless coordination messages 116 and interpret them to suppress or forego their voice response to the voice trigger phrase 122 (when the voice trigger phrase 122 is detected by the respective voice responsive modules 114 through the respective microphones 106.)

In one version, the wireless communication messages 116 can express a range of suppression of voice trigger response, and the wireless coordination message 116 sent to suppress the response to the voice trigger phrase 122 indicates a maximum in this range. For example, the range of suppression of voice trigger response could go from minimum, meaning do not suppress and always respond to a voice trigger, through medium, meaning respond to a detected voice trigger if no other electronic device declares it is responding to the voice trigger, to maximum, meaning do not respond to the voice trigger regardless of messages received from other devices. Further conditions for responding or suppressing could be represented in this range.

In some versions, the electronic devices that are participating in communication through the wireless communication messages 116 will vote as to which of them responds to a voice trigger phrase 122. The possibility that all of the electronic devices vote and decide communally that no device will respond to the voice trigger might achieve the same result as the combination of the self-suppression and external suppression techniques described above.

In various scenarios, a wireless coordination message 116 could communicate to a receiving device that the latter should not handle a voice trigger phrase 122, meaning that it effectively instructs a receiving device that if the device “hears” the voice trigger phrase 122 through its microphone output signal, the virtual assistant in the device should not respond. Alternatively, the coordination message 116 may be conveying that the sending electronic device (the playback device 138) is producing the sound that has the voice trigger phrase 122 (which is about to be, or is being, “heard” by the receiving device.) Further messages are readily devised in keeping with the teachings herein.

To summarize, for self-suppression 126, the voice trigger response suppression module 112 communicates to the voice responsive module 114 of the same electronic device. Also, for external suppression 128, the voice trigger response suppression module 112 communicates out through the wireless communication module 110 and the antenna 108, to send the wireless coordination message 116 (see FIG. 1) to one or more other wireless receiving devices. Thus, the voice trigger response suppression module 112 performs both self-suppression 126 and external suppression 128 of other electronic devices, in response to detecting the voice trigger phrase 122 in the signal to the speaker 104.

The reverse communication path is also available in an electronic device, for another electronic device to send wireless coordination message(s) 116 to be received by the electronic device depicted in FIG. 1. For example, when another electronic device, e.g., the smart speaker 118 or the desktop computer 120 in FIG. 1, detects the voice trigger phrase 122 in a signal to a speaker of that device, a similar mechanism is employed by that electronic device to send out a message indicating other electronic devices should suppress voice trigger response to the voice trigger phrase detected from their microphones 106. The present electronic device receives such a message through the antenna 108 and wireless communication module 110, communicating the message to the voice trigger response suppression module 112. The voice trigger response suppression module 112 then communicates to the voice responsive module 114, directing the voice responsive module 114 to ignore, suppress, disregard or not respond to the voice trigger detection from the microphone 106. This refers to the playback device 138 and receiving device role reversal mentioned above.

In one aspect, the voice trigger response suppression module 112 or the voice responsive module 114 could set or clear a flag that indicates to respond or not respond, respectively, to detection of the voice trigger phrase 122, deactivate use of the voice trigger detection module 130 by the voice responsive module 114, trap or intercept a message from the voice trigger detection module 130 to the voice responsive module 114, or otherwise disable or defeat response by the voice responsive module 114 to an indication that the voice trigger detection module 130 has detected the voice trigger phrase 122. In this manner, the voice responsive module 114 is not activated by the voice trigger detection from the microphone 106, thus performing suppression of response to the voice trigger phrase 122, as directed by a remote electronic device. Similar mechanisms can be employed for self-suppression 126.

Sending the wireless coordination message 116, to instruct wireless receiving devices to forego responding to their internal detections of a voice trigger phrase 122, can be termed an out of band communication, since the message 116 is not in the audio band in which the voice trigger phrase 122 is found. In a variation, instead of or in addition to sending the wireless coordination message 116, the voice trigger response suppression module 112 could embed a suppression signal into the audio signal that is being routed to the speaker 104 (for example through signaling with the audio rendering module 124)—the suppression signal is now referred to as an in-band signal. The suppression signal could be an ultrahigh frequency signal that is not audible to the human hearing range (e.g., ultrasound), acting as a watermark embedded in the audio signal. A receiving device, upon detecting the watermark within its microphone output signal, will respond by suppressing, e.g., ignoring the voice trigger phrase 122 or foregoing its voice response to the detected (here, heard via a microphone) voice trigger phrase 122. In a version where both the wireless coordination message 116 out of band signal and the embedded watermark in-band signal are sent by the electronic device, a receiving electronic device could monitor for one, the other or both signals.

In some user listening scenarios, for example where there are virtual assistant devices in adjoining rooms or closely spaced dwellings, it may be desirable to configure the electronic devices described above so that the embedded watermark is audible (to a receiving device) in the same room only, and serves to suppress voice responses (to the voice trigger phrase 122) in that room only. This means that receiving devices in other rooms will not suppress their voice responses (even though they receive the wireless coordination message 116 through walls) when hearing the voice trigger phrase 122. In other words, the suppression of the voice response is confined to those virtual assistant devices that are in the same user sound field as the playback device 138—a desirable result since listeners in other rooms should be allowed to use their own, in-room virtual assistant devices. In one version of this mechanism, the suppression decision in each receiving device is not automatic (upon receiving the wireless coordination message 116) but rather is voted on, by the playback device 138 and by the receiving devices, upon receipt of a wireless coordination message 116 directing to suppress. Only if a receiving device also detects the embedded watermark could it vote to suppress its own voice response to the detected voice trigger. Thus, a group of such electronic devices in the same room decide, as a group through the voting, to suppress their respective responses to the voice trigger. Meanwhile, an electronic device located in a neighbor room or dwelling, and also receiving the wireless coordination message 116, does not detect the embedded watermark (e.g., because the in-band audio signal has been acoustically damped by walls), and is thus free to respond to the voice trigger phrase 122. This assumes that the electronic devices in the neighboring room might receive the wireless coordination message 116, but do not detect the embedded watermark and so do not vote to suppress their response to the voice trigger. This allows those other receiving devices to be used normally in the other rooms (and respond to their hearing of the voice trigger phrase 122.)

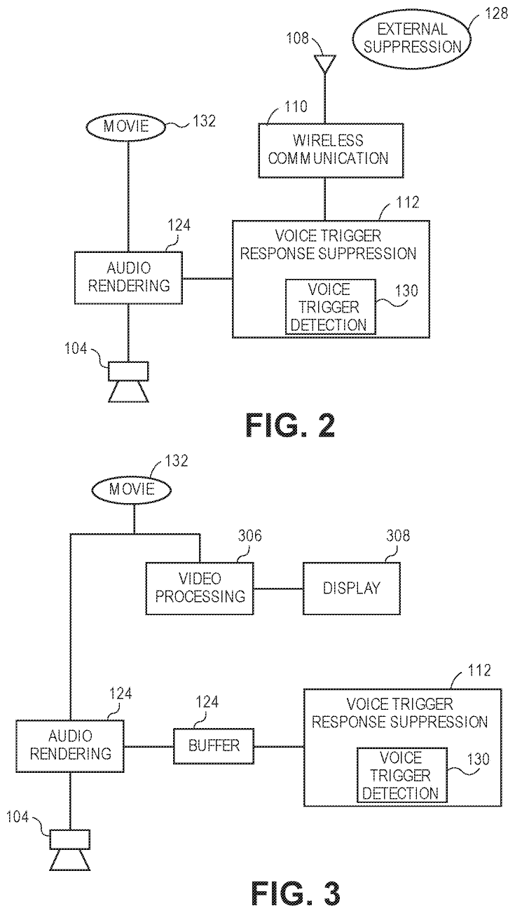

FIG. 2 depicts a variation of the electronic device of FIG. 1, with a subset of the features described therein. In this example, the electronic device has audio rendering module 124, voice trigger detection module 130, voice trigger response suppression module 112 and wireless communication module 110 with antenna 108, but no voice responsive module 114 (it may lack both the speaker 104 and the microphone 106 of FIG. 1.) This electronic device shown in FIG. 2 can still detect the voice trigger phrase 122 in the signal to speaker and send a wireless coordination message 116 for external suppression 128 in order to suppress voice trigger response in other electronic devices. However, it neither has nor needs self-suppression 126, since it lacks the voice responsive module 114. The electronic device could have a speaker 104, for outputting the audio signal as sound, or it could send an audio playback signal through wireless communication module 110 to another device that has a speaker 104 to reproduce the audio signal. Examples of suitable electronic devices for this version include audio playback devices and video playback devices that are not voice responsive, e.g., a dedicated DVD player that has audio rendering module 124 and video processing module 306 (for decoding the movie 132 and rendering it for a display 308—see FIG. 3.)

FIG. 3 is a block diagram depicting a playback device in which an audio signal (e.g., from a soundtrack of a movie 132) is received into a buffer 302. The voice trigger detection module 130 monitors the audio signal through a separate or dedicated buffer 302 that is in parallel with another path of the audio signal that is directed to the speaker 4. This is one example of how the voice trigger detection module 130 is connected and functions to detect the voice trigger phrase 122 in an audio signal that is being routed to the speaker 104. The movie 132 or other user program audio, which could be streaming from a remote device or being read from local memory, is also provided to a video processing module 306 (in addition to the audio rendering module 124.) Output of the video processing module 306 is provided to a display 308, e.g., through a wired or wireless video communication link (not shown), upon which the user watches the movie 132. Output of the audio rendering module 124 is routed, e.g., as one or more speaker driver signals, to the speaker 104, from which the user listens to the soundtrack of the movie 132. An audio signal from the audio rendering module 124 (either the program audio at a point upstream of the module 124 or a driver signal downstream of the module 124) which is intended for the speaker 104 is also input to a buffer 302, which thus temporarily holds audio data. The voice trigger detection module 130 monitors the output of the buffer 302 for the voice trigger phrase 122. When the voice trigger phrase 122 is detected, the voice trigger response suppression module 112 is signaled to perform self-suppression 126 and/or external suppression 128 in various versions as described above with reference to FIGS. 1 and 2.

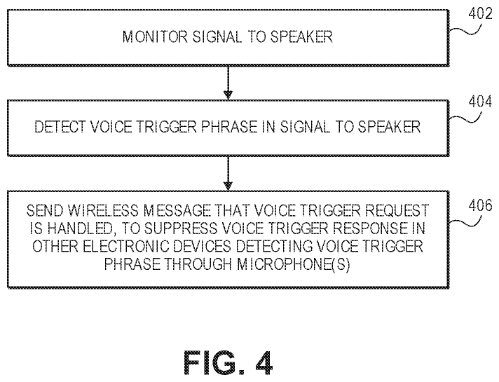

FIG. 4 is a flow diagram of a method of voice trigger response suppression for electronic devices, which can be practiced by an electronic device.

In an action 402, a signal to a speaker is monitored. For example, a voice trigger response suppression module in an electronic device could perform the monitoring of the signal through a buffer.

In an action 404, the voice trigger phrase is detected in the signal to the speaker. For example, a voice trigger detection module could detect the voice trigger phrase.

In an action 406, a wireless message is sent, in response to detecting the voice trigger phrase in the signal to the speaker. The wireless message declares that the voice trigger request is handled. The wireless message is to suppress voice trigger response in other electronic devices detecting the voice trigger phrase through respective microphone(s).

Various modules and processing in this disclosure may be implemented with one or more digital processors (generically referred to here as “a processor”) that execute instructions stored in memory to perform the acts of the modules or processes that are recited in this disclosure. In most cases, the processor and its memory will be in the same housing of an electronic device. Some of the modules may also include analog circuitry, for example an RF transceiver in a wireless communication module, and audio amplifiers in an audio codec module.

While certain aspects have been described and shown in the accompanying drawings, it is to be understood that such are merely illustrative of and not restrictive on the broad disclosure, and that the disclosure is not limited to the specific constructions and arrangements shown and described, since various other modifications may occur to those of ordinary skill in the art. For example, while the description above refers to a microphone output signal and the figures show a single microphone 106, it should be understood that such a description also covers the case where there may be multiple microphones (e.g., a microphone array serving as multi-channel sound pickup) whose outputs may be processed separately for multiple voice trigger detections, or combined into a beamformer output signal (before being processed for voice trigger phrase detection.) The description is thus to be regarded as illustrative instead of limiting.

What is claimed is:

1. An electronic device with voice trigger response suppression capability, the device comprising:
a wireless communication module;
an audio rendering module configured to generate a speaker driver audio signal based on processing user program audio; and
a voice trigger response suppression module configured to:
monitor the user program audio or the speaker driver audio signal to detect a voice trigger phrase therein, wherein detection of the voice trigger phrase normally causes activation of a virtual assistant that produces a voice response in response to recognizing speech; and
responsive to detecting the voice trigger phrase in the user program audio or in the speaker driver audio signal, cause an over the air message to be sent through the wireless communication module to communicate to one or more wireless receiving devices that the electronic device with voice trigger response suppression capability is handling virtual assistant response to a voice trigger.

2. The electronic device with voice trigger response suppression capability of claim 1, further comprising:
a voice responsive module configured to detect the voice trigger phrase in a microphone output signal and produce a voice response to recognized speech in the microphone output signal,
wherein the voice trigger response suppression module is to communicate to the voice responsive module to disregard the voice trigger phrase in the microphone output signal, responsive to detecting the voice trigger phrase in the speaker driver audio signal.

3. The electronic device with voice trigger response suppression capability of claim 2 further comprising:
a speaker to receive the speaker driver audio signal and a microphone to produce the microphone output signal, wherein the wireless communication module, the speaker, the audio rendering module, the microphone and the voice trigger response suppression module are integrated within a smartphone, a laptop computer, a desktop computer, a tablet computer, a smart speaker, or an in-vehicle infotainment system.

4. The electronic device with voice trigger response suppression capability of claim 2 wherein the wireless communication module is to receive the microphone output signal from a remote microphone.

5. The electronic device with voice trigger response suppression capability of claim 1, wherein the wireless communication module, the voice trigger response suppression module, and the audio rendering module are integrated in a digital media player or network appliance.

6. The electronic device with voice trigger response suppression capability of claim 5 wherein the digital media player or network appliance comprises an interface to an audio video communications cable through which the speaker driver audio signal is to be transmitted to a speaker.

7. The electronic device with voice trigger response suppression capability of claim 1, wherein the message, sent through the wireless communication module, is one of a plurality of coordination messages each being sent in response to detection of the voice trigger phrase and using which a plurality of electronic devices participate to elect a winner in event of multiple device detections of the voice trigger phrase.

8. The electronic device with voice trigger response suppression capability of claim 1, further comprising:
a microphone;
a voice responsive module to detect and respond to the voice trigger phrase when received through the microphone;
the wireless communication module is to participate in wireless coordination messages to elect a winner in event of multiple device detections of the voice trigger phrase; and
the wireless communication module and the voice responsive module to coordinate to disregard the voice trigger phrase when received through the microphone and notified through one of the wireless coordination messages that another electronic device with voice trigger response suppression capability will handle the virtual assistant response to the voice trigger.

9. The electronic device with voice trigger response suppression capability of claim 1, further comprising:
a buffer coupled in parallel to a path of the speaker driver audio signal, wherein the voice trigger response suppression module is to process output of the buffer for detecting the voice trigger phrase.

10. The electronic device with voice trigger response suppression capability of claim 1, wherein the message is to indicate to the one or more wireless receiving devices a maximum in a range of suppression of voice trigger response.

11. A method of voice trigger response suppression for electronic devices, comprising:
monitoring, by a voice trigger response suppression module in an electronic device, a signal to a speaker of the electronic device;
detecting a voice trigger phrase, through the monitoring; and
sending a message through a wireless communication module of the electronic device to communicate to one or more wireless receiving devices that the electronic device will handle a voice trigger request, responsive to the detecting the voice trigger phrase through the monitoring the signal to the speaker.

12. The method of voice trigger response suppression for electronic devices of claim 11, further comprising:
communicating, from the voice trigger response suppression module to a voice responsive module that detects and responds to voice trigger phrases received through a microphone of the electronic device, to disregard detection of the voice trigger phrase as received through the microphone, responsive to detecting the voice trigger phrase through monitoring of the signal to the speaker.

13. The method of voice trigger response suppression for electronic devices of claim 11 wherein the monitoring, the detecting and the sending are in a smart phone, a laptop computer, a desktop computer or an in-vehicle infotainment system.

14. The method of voice trigger response suppression for electronic devices of claim 11, wherein the monitoring, the detecting and the sending are in a smart speaker.

15. The method of voice trigger response suppression for electronic devices of claim 11 further comprising
embedding a suppression signal into the signal to the speaker, wherein a receiving device, upon detecting the suppression signal within its microphone output signal is to respond by suppressing a virtual assistant response in the receiving device to the voice trigger phrase.

16. The method of voice trigger response suppression for electronic devices of claim 15 wherein the receiving device responds, by suppressing a virtual assistant response in the receiving device to the voice trigger phrase, only if it has detected the suppression signal within its microphone output signal.

17. The method of voice trigger response suppression for electronic devices of claim 11, further comprising:
outputting for playback a soundtrack of a movie through the signal to the speaker, wherein the detecting the voice trigger phrase comprises detecting the voice trigger phrase in the soundtrack of the movie during the outputting for playback.

17. The method of voice trigger response suppression for electronic devices of claim 11 wherein the sending the message to communicate to the one or more wireless receiving devices comprises participating in wireless coordination messages to elect a winner in event of multiple device detections of the voice trigger phrase.

18. The method of voice trigger response suppression for electronic devices of claim 11, further comprising, by one or more of the wireless receiving devices:
disregarding the voice trigger phrase when received through a microphone of the wireless receiving device in response to receiving the message that another electronic device will handle the voice trigger request.

19. An electronic device with voice trigger suppression, comprising:
a wireless communication module;
a processor; and
memory having store therein a first virtual assistant and instructions that when executed by the processor
render user program audio for output by a speaker, and
monitor the user program audio as output by the speaker through a first microphone output signal, to detect a trigger therein, and responsive to detecting the trigger send a message through the wireless communication module to a wireless receiving device in which a second virtual assistant is monitoring the user program audio, as output by the speaker, through a second microphone output signal,
wherein the second virtual assistant in the wireless receiving device is configured to normally respond to detection of the trigger in the second microphone output signal but foregoes from doing so in response to the message being received.

20. The electronic device with voice trigger suppression of claim 19 wherein the memory has stored therein further instructions that when executed by the processor prevent the first virtual assistant from responding to detection of the trigger in the first microphone output signal.

21. The electronic device with voice trigger suppression of claim 19 wherein the message is to instruct the wireless receiving device to suppress any voice response of the second virtual assistant to detection of the trigger in the second microphone output signal.
